(19) United States
(12) Patent Application Publication
(10) Pub. No.: US 2024/0002233 A1
(43) Pub. Date: Jan. 4, 2024

(54) USING CONVERTED SOLID CARBON FROM CAPTURED CARBON DIOXIDE TO POWER WELLBORE EQUIPMENT

(71) Applicant: Halliburton Energy Services, Inc., Houston, TX (US)

(72) Inventors: Philip D NGUYEN, Houston, TX (US); Ronald Glen DUSTERHOFT, Houston, TX (US); Brian Alan EVANS, Houston, TX (US); Stanley Vernon STEPHENSON, Houston, TX (US)

(73) Assignee: Halliburton Energy Services, Inc., Houston, TX (US)

(21) Appl. No.: 17/809,644

(22) Filed: Jun. 29, 2022

(51) Int. Cl. E21B 41/00

(52) U.S. Cl. CPC E21B 41/0064; E21B 41/0085; B01J 23/89

(57) ABSTRACT

Oxygen and solid carbon can be produced by reacting captured carbon dioxide with a catalyst in a reaction chamber. A liquid base fluid can form a continuous phase within the reaction chamber with a plurality of liquid metal carrier droplets dispersed in the base fluid. The catalyst can be nano-sized particles that can coat the surfaces of the carrier droplets. Agitation can be supplied to the reaction chamber to maintain dispersion of the liquid metal carrier droplets and increase contact of the carbon dioxide and catalyst particles. The reaction temperature can be less than the temperature required for other processes that produce solid carbon. The solid carbon and the oxygen can be used as a power source for wellsite equipment in the form of fuel cells to generate electricity or power or used to charge batteries.

### TECHNICAL FIELD

Captured carbon dioxide can be converted into oxygen gas and solid carbon. The solid carbon can be used as a power source for wellsite equipment. The oxygen can be used to improve the efficiency of hydrogen fuel cells used as a power source for wellsite equipment.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a schematic illustration of reaction chambers for converting captured carbon dioxide into oxygen gas and solid carbon according to certain embodiments.

### DETAILED DESCRIPTION

Carbon dioxide (CO₂) is released into the atmosphere by a variety of processes. One example is heavy industries, such as the steel and cement industries, that emit carbon dioxide during processing. Globally, power generation plants emit nearly 10 billion tons of carbon dioxide per year. Transport accounts for approximately on-fifth of the global carbon dioxide emissions. Landfills also produce gas when bacteria break down organic waste with 90-98% of the gas being methane and carbon dioxide. It is estimated that landfills in the United States release over 100 million metric tons of carbon dioxide equivalent (MMTCO₂e) of gas into the atmosphere in 2020. There are also other processes, such as those that can produce hydrogen gas, that produce carbon dioxide as a by-product in the process.

There are several ways in which companies have attempted to reduce the amount of carbon dioxide (CO₂) in the atmosphere. For example, decarbonization, which seeks to reduce carbon dioxide emissions through the use of low carbon power sources, is a technical challenge for many industries because decarbonization is not only energy-intensive but also directly emits CO₂ as part of the production process. By way of another example, capturing CO₂, compressing it to a liquid form, and then transporting it and ultimately injecting it into sites underground has proven to be economically and environmentally unfeasible.

There are processes that have attempted to convert captured carbon dioxide into oxygen and carbon. However, there are several problems with these processes. Most of the processes utilize a catalyst that splits the carbon-oxygen bonds. However, the reduction of CO₂ to solid carbon and oxygen is challenging because the product may cover the catalyst's surface through van der Waals adhesion, thereby blocking access to catalytically active sites and causing damage to the catalyst in a process known as coking. Previous methods of converting captured CO₂ into solid carbon require extremely high temperatures, thus, making the process not viable for practical purposes. Solid metals have been used in CO₂ reduction; however, this approach results in very low efficiencies, poor selectivity, and is unstable. One of the most widely used process is amine absorption. However, amine absorption is quite a complex process and very energy intensive due to the requirement for cooling and heating. Thus, there is a long-felt need for improved processes that generate solid carbon from carbon dioxide.

It has been discovered that captured carbon dioxide can be converted into solid carbon and oxygen gas at lower temperatures than other processes and at a higher efficiency. The solid carbon can be used as a fuel in direct carbon fuel cells (DCFC) for generating electricity or to charge batteries. The solid carbon can be utilized for other industrial processes and potentially for carbon ion batteries that could provide more efficient battery storage of electricity in the future. The oxygen can be used to improve the efficiency of hydrogen fuel cells used as a power source for wellsite equipment.

A method of supplying power to wellbore equipment can comprise: (1) obtaining solid carbon produced by: (A) introducing captured carbon dioxide into a reaction chamber; (B) agitating a liquid base fluid, a plurality of carrier droplets, and a catalyst in the reaction chamber; (C) allowing the captured carbon dioxide to react with the catalyst in the reaction chamber to form the oxygen gas and solid carbon; (D) removing the oxygen gas from the reaction chamber; and (E) removing the solid carbon from the reaction chamber; and (2) using the solid carbon to power the wellbore equipment.

The carbon dioxide is captured carbon dioxide. Captured carbon dioxide is captured from a carbon dioxide source before it is released into the atmosphere. The carbon dioxide can be captured from a variety of locations. The carbon dioxide can be captured from exhaust gas produced from wellsite equipment used during an oil or gas operation. Carbon dioxide can also be a component of produced gas during oil or gas production operations. The carbon dioxide can also be captured from exhaust gas from other types of equipment besides oil or gas operations, such as heavy industries whose processes can produce carbon dioxide. According to any of the embodiments, the exhaust gas collected equipment is first passed through a heat exchanger to lower its temperature to below 65° C. and then passed through a filtering device to remove soot and solid particulates before introducing this filtered exhaust gas into the reaction chamber. The carbon dioxide can also be captured from landfills. The carbon dioxide can be captured into a variety of receptacles, such as pipes, storage tanks, or membranes. According to any of the embodiments, the gas introduced into the reaction chamber is 100% carbon dioxide. The methods can further comprise separating carbon dioxide from other gases or solid particulates if the captured fluid is not pure carbon dioxide. The separation of carbon dioxide can include flowing the captured fluid through a membrane. The membrane can selectively retain other gases or solid particulates and allow carbon dioxide to pass through the membrane. In this manner, only captured carbon dioxide is introduced into the reaction chamber.

A system for converting captured carbon dioxide into oxygen gas and solid carbon can include a reaction chamber. The reaction chamber can include a chamber and a fluid inlet. As used herein, a “fluid” is a substance having a continuous phase that can flow and conform to the outline of its container when the substance is tested at a temperature of 71° F. (22° C.) and a pressure of one atmosphere “atm” (0.1 megapascals “MPa”). A fluid can be a liquid or gas. The fluid inlet can be located near a bottom of the chamber. A homogenous fluid has only one phase; whereas a heterogeneous fluid has more than one distinct phase. A colloid is an example of a heterogeneous fluid. A heterogeneous fluid can be a slurry, which includes a continuous liquid phase and undissolved solid particles as the dispersed phase; an emulsion, which includes a continuous liquid phase and at least one dispersed phase of immiscible liquid droplets; a foam, which includes a continuous liquid phase and a gas as the dispersed phase; or a mist, which includes a continuous gas phase and liquid droplets as the dispersed phase. As used herein, the term “base fluid” means the solvent of a solution or the continuous phase of a heterogeneous fluid and is the liquid that is in the greatest percentage by volume of a heterogeneous fluid. The captured carbon dioxide can be introduced into the chamber of the reaction chamber via the fluid inlet.

The captured carbon dioxide reacts with a catalyst to form oxygen gas and solid carbon. The catalyst can break the carbon-oxygen bonds of the carbon dioxide to produce oxygen gas and solid carbon as shown in Eq. 1 below. The catalyst can be a metal, a metal alloy, or a metal salt. As used herein, the term “metal alloy” means a mixture of two or more elements, wherein at least one of the elements is a metal. The other element(s) can be a non-metal or a different metal. An example of a metal and non-metal alloy is steel, comprising the metal element iron and the non-metal element carbon. An example of a metal and metal alloy is bronze, comprising the metallic elements copper and tin. As used herein, the term “metal” means any substance that comprises a metal and includes pure metals and metal alloys.

$${CO}_{2 ( a q )} {\to }^{yields} {C}_{( s )} + {O}_{2 ( g )} \qquad Eq . 1$$

The catalyst can be a pure metal or metal alloy selected from the group consisting of copper, nickel, cobalt, iron, manganese, chromium, vanadium, palladium, platinum, gold, silver, ruthenium, rhodium, iridium, and combinations thereof. A catalyst metal alloy can also include any of the aforementioned metals alloyed with a non-metal. The catalyst can also be a salt of any of the aforementioned metals. The metal salt can be selected from the group consisting of a metal chloride, metal fluoride, metal bromide, metal iodide, metal nitrate, metal triflate, and combinations thereof. By way of example, the metal of the metal salt is a silver salt. According to any of the embodiments, the catalyst is a metal salt selected from the group consisting of silver chloride, silver fluoride, silver bromide, silver iodide, silver triflate, and combinations thereof. The metal of the catalyst can be a post-transition metal. The post-transition metal can be selected from the group consisting of aluminum, gallium, indium, thallium, tin, bismuth, and combinations thereof. The post-transition metal can be alloyed with an alkali metal, alkaline earth metal, actinide metal, lanthanide metal, transition metal, or combinations thereof.

The catalyst can be a solid. The catalyst can be plurality of particles. The catalyst can have a mean particle size less than 10 micrometers. The catalyst can have a mean particle size in the range of 10 to 100 nanometers (0.01 to 1 micrometers). The mean particle size of the catalyst can be selected such that an increased surface area is available for reacting with the captured carbon dioxide.

The system also includes a plurality of carrier droplets. The carrier droplets can comprise a metal. As used herein, the term “droplet” means a very small drop of liquid. The metal can be in liquid form. The metal for the carrier droplets can be selected from post-transition metal. The metal for the carrier droplets can be selected from the group consisting of aluminum, gallium, indium, thallium, tin, bismuth, and combinations thereof. The post-transition metal can also be alloyed with an alkali metal, alkaline earth metal, actinide metal, lanthanide metal, transition metal, or combinations thereof. The plurality of carrier droplets can have a mean diameter less than 100 micrometers. The plurality of carrier droplets can have a mean diameter in the range of 0.1 to 50 micrometers. It is to be understood that the use of the term droplet does not limit the liquid droplets to any particular shape (e.g., spherical) or require each droplet to have uniform dimensions. Moreover, any uniform dimensions and shape can also change during agitation in the reaction chamber.

The plurality of carrier droplets can be a metal that has a melting point below 300° C., 200° C., 150° C., 100° C., or 60° C. According to any of the embodiments, the metal of the plurality of carrier droplets has a melting point less than or equal to ambient temperature (˜75° F. (24° C.)). By way of example, pure gallium has a melting point of about 30° C. and alloys of gallium with other metals can have a melting point close to 24° C.

The system can also include a liquid base fluid. The liquid base fluid can form a continuous phase within the reaction chamber wherein the plurality of carrier droplets, the catalyst, and the captured carbon dioxide can be a dispersed phase within the liquid base fluid. According to any of the embodiments, the liquid base fluid does not solubilize or negligibly solubilizes the catalyst solid particles or the plurality of carrier droplets. According to any of the embodiments, the liquid base fluid is not consumed by, nor takes part in, the reaction of the catalyst and the captured carbon dioxide. The liquid base fluid can be, for example, an ionic liquid or an organic liquid. Examples of ionic liquids include 1-alkyl-3-methylimidazolium, 1-alkyl-1-pyrrolidinium, 1-alkylpyridinium, trialkylsulfonium, n-alkylphosphonium, tetraalkylammonium, tetraalkylphosphonium, dicyanamide, acetate, halogen, trifluoroacetate, hexafluorophosphate, tetrafluoroborate, alkyl sulfonate, alkyl sulfate, alkyl phosphate, bis(trifluoromethylsulfonyl)imide, and combinations thereof. Examples of organic liquids include alkanolamines, dimethylformamide, acetonitrile, cyclohexane, diethylene glycol dimethyl ether, ethylene glycol, glycerol, 2-amino-2-methyl-1-propanol, benzylamine, piperazine, 1,2-ethanediamine, 3-methylamine propylamine, pyridine, triethylamine, xylene, propanol, butanol, ethanol, methanol, acetone, methyl acetate, acetylacetone, 1,4-dioxane, 2-methoxyethyl acetate, N,N-dimethylacetamide, 2-butoxyethyl acetate, N-tert-butylformamide, 2-(2-butoxyethoxy)ethyl acetate, formamide, poly(ethylene glycol), carbonate (such as sodium, potassium or calcium carbonate), bicarbonate (such as sodium or potassium bicarbonate etc.). The liquid base fluid can also be water or mixture of any two or more of disclosed liquids. The liquid base fluid can be a polar solvent since carbon dioxide gas is a polar fluid. A polar liquid base solvent enhances the solubility of carbon dioxide gas in the liquid base fluid.

One or more surfactants can also be included. The surfactant can enhance dispersion of the plurality of carrier droplets throughout the liquid base fluid. The surfactant can be anionic, cationic, or non-ionic.

The catalyst, the plurality of carrier droplets, and the liquid base fluid can be added to the chamber of the reaction chamber at the same time or different times. By way of example, the liquid base fluid, the catalyst particles, and the liquid metal carrier droplets can be pre-mixed in a separate container to allow the liquid metal to form a dispersion of fine droplets suspended in the liquid base fluid, and then this dispersion can be added to the chamber of the reaction chamber.

The methods include agitating the liquid base fluid, plurality of carrier droplets, and the catalyst in the reaction chamber. Any form of mechanical agitation can be applied to the contents in the reaction chamber to ensure dispersion of the liquid metal carrier into fine droplets in the liquid base fluid. Examples of mechanical agitation include, but are not limited to, sonication, vibration, homogenization, rapid stirring, blending, or mixing. The system can also include an agitator, for example a motor and one or more mixing blades, to agitate the contents in the reaction chamber.

The plurality of carrier droplets can be a carrier for the catalyst particles. The catalyst particles can have an affinity for the plurality of carrier droplets and can coat the outside of the droplets and also become intermixed within the droplets. The amount of agitation of the contents in the reaction chamber can be selected such that the liquid metal carrier droplets have desired dimensions. By way of example, increased agitation can produce droplets having smaller dimensions than lower agitation. The dimensions of the droplets and the concentration of the liquid metal carrier can provide a desired surface area of the plurality of carrier droplets, which increases the surface area of the catalyst particles that react with the captured carbon dioxide. The liquid base fluid or solvent can help disperse the liquid metal carrier droplets with the help of mechanical agitation. The catalyst particles are dispersed in the liquid metal carrier droplets. The liquid metal carrier droplets can prevent coking or coating of solid carbon (produced from carbon dioxide reduction) on the catalyst nanoparticles and the liquid metal droplets themselves, thereby allowing fresh surfaces of catalyst particles to react with the carbon dioxide dissolved in the liquid base solvent. The small size of the droplets provides large surface areas for the catalytic sites between the catalyst particulates and the carbon dioxide. The low density of produced solid carbon and the smooth surface of liquid metal droplets enhance detachment of produced solid carbon from the liquid metal droplets, allowing it to float to the top of the reaction chamber to be separated and collected.

The methods include allowing the captured carbon dioxide to react with the catalyst in the reaction chamber to form oxygen gas and solid carbon. The solid carbon can be in the form of particulates. The solid carbon can float to the top of the liquid base fluid in the reaction chamber.

According to any of the embodiments, the mechanical agitation is continuously applied to the contents in the reaction chamber during the reaction time (i.e., the length of time that the captured carbon dioxide is in contact with liquid metal carrier droplets and the catalyst particles). Continuous agitation can be used to keep the liquid metal carrier as a plurality of droplets in the dispersion, prevent the plurality of carrier droplets from coalescing, enhance detachment of the solid carbon particulates from the surfaces of the plurality of carrier droplets, and cause the solid carbon to float to the top of the liquid base fluid in the reaction chamber.

The captured carbon dioxide can be introduced into the bottom of the reaction chamber via an inlet (discussed above). The inlet can include a diffuser that causes the captured carbon dioxide to enter the reaction chamber as bubbles. Bubbled carbon dioxide can more easily react with the catalyst on the plurality of carrier droplets as the carbon dioxide rises to the top of the reaction chamber. The inlet can include one or more components that can control the flow rate and amount of the captured carbon dioxide that is being introduced into the reaction chamber. There can also be more than one inlet that is used to introduce the captured carbon dioxide into the reaction chamber. The inner diameter of the one or more inlets can be selected such that a desired flow rate of the captured carbon dioxide into the reaction chamber can be achieved.

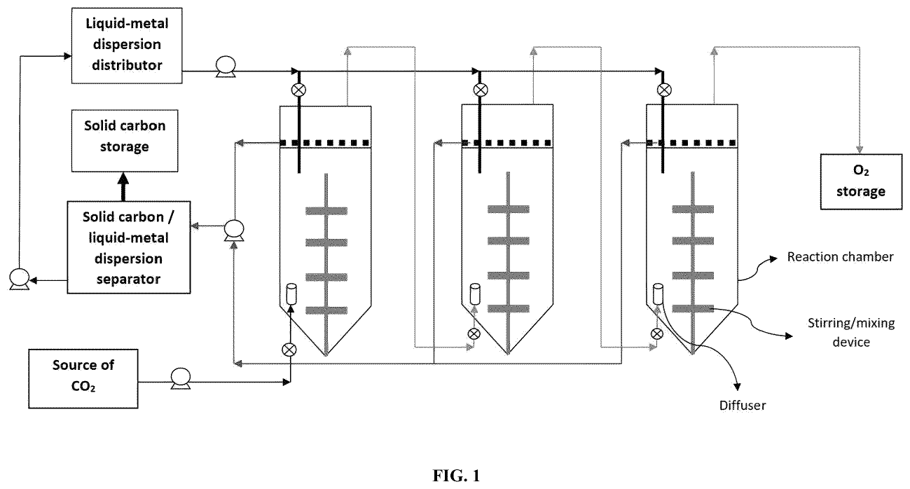

As shown in FIG. 1, the reaction chamber can also include a first outlet. The first outlet can be located adjacent to the surface of the liquid base fluid. The methods include removing the solid carbon from the reaction chamber. The solid carbon can be removed by drawing a top portion of the liquid base fluid, carrier droplets, catalyst, solid carbon mixture into the first outlet. It is to be understood that some or all of the following may be located at the surface of the liquid within the chamber: the liquid base fluid, the surfactant if used, a portion of the liquid metal carrier droplets, the catalyst particles, and the solid carbon. Accordingly, only the liquid base fluid and the solid carbon may be located at the surface of the liquid in some instances, while in other instances a portion of the liquid metal carrier droplets can also be located at the surface. The solid carbon can be separated from the liquid base fluid and liquid metal carrier droplets and catalyst in a separator after being removed from the reaction chamber. The solid carbon can then be stored in a storage vessel.

The reaction chamber can also include a second outlet. The second outlet can be located at the top of the chamber. The produced oxygen gas and any unreacted carbon dioxide can be located at the top of the chamber and can be withdrawn from the reaction chamber via the second outlet.

According to any of the embodiments, one reaction chamber is used in the system. According to these embodiments, any or all of the following can be modified to achieve a desired efficiency of converting the captured carbon dioxide to oxygen gas and solid carbon: the dimensions of the reaction chamber, the concentration of the liquid base fluid, the concentration of the plurality of carrier droplets, the concentration of the catalyst, the flow rate of the captured carbon dioxide into the reaction chamber, and the type, duration, and force of the mechanical agitation. The desired efficiency can range from 50% to 90%.

As can be seen in FIG. 1, there can be more than one reaction chamber connected in series. According to these embodiments, the captured carbon dioxide can be bubbled up through a first reaction chamber. After the desired reaction time, the top portion of liquid base fluid, solid carbon, liquid metal carrier, catalyst, or combinations thereof can be removed from the first reaction chamber via a first outlet. The produced oxygen gas and any unreacted carbon dioxide can be removed from the reaction chamber via the second outlet. The solid carbon can be separated from the liquid base fluid, liquid metal carrier, and/or catalyst via a separator and then stored in a carbon storage vessel. The liquid base fluid, liquid metal carrier, and/or catalyst that has been separated from the solid carbon can then be introduced into the first reaction chamber or other reaction chambers via an inlet. The oxygen gas and unreacted carbon dioxide can then be flowed from the first reaction chamber into a second reaction chamber via an inlet located at the bottom of the second reaction chamber. The second reaction chamber can include the liquid base fluid, plurality of carrier droplets, and catalyst particles. The process used in the first reaction chamber for reacting carbon dioxide with the catalyst can be used in the second reaction chamber, a third reaction chamber, and so on. Each of the additional reaction chambers can have the same components (e.g., inlet, outlets, agitator, etc.) as the first reaction chamber. In this manner, the desired efficiency of converting the captured carbon dioxide to oxygen gas and solid carbon can be achieved. The oxygen gas can be stored in an oxygen storage vessel.

According to any of the embodiments, the catalyst is not used up during the reaction with the captured carbon dioxide. However, some of the catalyst particles may need to replenish the catalyst particles remaining in the reaction chamber. For example, full recovery of the catalyst particles from the solid carbon/liquid metal carrier separator may not be possible. Therefore, the concentration of the catalyst particles may become diminished, and the desired efficiency may not be achieved.

The temperature of the liquid base fluid is preferably greater than or equal to the melting point of the metal of the carrier droplets. In this manner, the carrier droplets can remain in liquid form for the duration of the reaction time. The system can further include a heat source for increasing the temperature of the liquid base fluid above the melting point of the metal carrier droplets. The heat source can be, for example, exhaust gas from equipment, a heating jacket placed wholly or partially around the reaction chamber, coils located around the outside of the reaction chamber in which a heated fluid can be flowed through, or heat produced from fuel cells—which advantageously utilizes green energy to heat the liquid base fluid.

One or more acids can be added to the liquid metal carrier droplets and base fluid to reduce any oxidation of the carrier droplets or catalyst's surface by dissolving any metal oxides that may form on the liquid metal carrier droplets before or during catalysis, for example reactions that form oxidizers, such as the molecular oxygen, produced by the reduction of carbon dioxide. Examples of acids include, but are not limited to, inorganic acids such as phosphoric acid, sulfuric acid, nitric acid, hydrochloric acid, boric acid, or bromic acid; or organic acids such as acetic acid, formic acid, citric acid, oxalic acid, or sulfonic acid.

The methods include obtaining solid carbon. The methods can further include producing the oxygen gas and solid carbon via the reactor and processes as described above. The methods can further include using the solid carbon in as a power source for wellsite equipment in oil and gas operations. The solid carbon that is produced can be used as a fuel source in direct carbon fuel cells (DCFC) for wellbore equipment. The solid carbon can also be used in the manufacture of carbon ion batteries for wellbore equipment. Carbon ion batteries are more reliable and have fewer safety concerns compared to other common batteries such as lithium batteries. Accordingly, the power for wellbore equipment can be in the form of fuel cells or batteries. As used herein, “wellbore equipment” means any equipment, tool, etc. that requires a source of power to operate and is used in oil or gas operations. Wellsite equipment includes equipment located above ground at or near the wellsite and below ground within or adjacent to a wellbore. According to any of the embodiments, the wellsite equipment is equipment used in hydraulic fracturing operations, drilling operations, or cementing operations. The wellsite equipment can also be submersible pumps, pumping units powered by electrical motors on surface, coiled tubing equipment, wireline equipment, pumping equipment for pump down, remediation and drill out operations, nitrogen pumping equipment, gas compression equipment, pipeline pumping equipment etc.

Hydrogen fuel cells can be used to produce electricity for wellsite equipment. The electricity produced from hydrogen fuel cells can also be used in charging the batteries that can be delivered to well sites to power wellbore equipment. The produced oxygen can be used to improve the efficiency of hydrogen fuel cells used as a power source for wellsite equipment. Typically, 80% of the losses in a hydrogen fuel cell are from compressing air to reach the required oxygen content for maximum efficiency of electricity generation. Accordingly, the produced oxygen from the reaction chamber can be used to supplement part or all of the air needed—depending on the hydrogen fuel cell capacity. Any supplementation will improve efficiency due to the total replacement and removal of the air compressor; thus, providing the maximum improvement in efficiency of the hydrogen fuel cell.

An embodiment of the present disclosure is a method of supplying power to wellsite equipment comprising: (1) obtaining oxygen gas, solid carbon, or oxygen gas and solid carbon produced by: (A) introducing captured carbon dioxide into a reaction chamber, wherein the reaction chamber contains a liquid base fluid, a plurality of carrier droplets, and a catalyst; and (B) allowing the captured carbon dioxide to react with the catalyst in the reaction chamber to form the oxygen gas and solid carbon; and (2) using the produced oxygen gas, the solid carbon, or the oxygen gas and the solid carbon to power the wellsite equipment. Optionally, the method further comprises wherein the carbon dioxide is captured from exhaust gas produced by wellsite equipment during oil or gas production operations. Optionally, the method further comprises wherein the carbon dioxide is captured from landfills or industry processes. Optionally, the method further comprises wherein the catalyst is a metal, a metal alloy, or a metal salt. Optionally, the method further comprises wherein the metal of the catalyst is selected from the group consisting of copper, nickel, cobalt, iron, manganese, chromium, vanadium, palladium, platinum, gold, silver, ruthenium, rhodium, iridium, aluminum, gallium, indium, thallium, tin, bismuth, and combinations thereof, and wherein the metal salt is selected from the group consisting of a metal chloride, metal fluoride, metal bromide, metal iodide, metal nitrate, metal triflate, silver chloride, silver fluoride, silver bromide, silver iodide, silver triflate, and combinations thereof. Optionally, the method further comprises wherein the catalyst is a plurality of solid particles. Optionally, the method further comprises wherein the plurality of solid particles has a mean particle size in the range of 10 to 100 nanometers. Optionally, the method further comprises wherein the plurality of carrier droplets comprises a pure metal or a metal alloy comprising a post-transition metal selected from the group consisting of aluminum, gallium, indium, thallium, tin, bismuth, and combinations thereof. Optionally, the method further comprises wherein the post-transition metal is alloyed with an alkali metal, alkaline earth metal, actinide metal, lanthanide metal, transition metal, or combinations thereof. Optionally, the method further comprises wherein the plurality of carrier droplets has a mean diameter in the range of 0.1 to 50 micrometers. Optionally, the method further comprises wherein the plurality of carrier droplets comprises a metal that has a melting point below 150° C. Optionally, the method further comprises wherein the liquid base fluid is a polar solvent. Optionally, the method further comprises wherein the plurality of carrier droplets comprises a metal, and wherein the liquid base fluid has a temperature greater than or equal to a melting point of the metal. Optionally, the method further comprises wherein the liquid base fluid, the plurality of carrier droplets, and the catalyst are agitated within the reaction chamber, wherein the agitation is mechanical agitation, and wherein the mechanical agitation is continuously applied to contents in the reaction chamber during a reaction time. Optionally, the method further comprises more than one reaction chamber connected in series. Optionally, the method further comprises wherein the oxygen gas is used to supplement oxygen in hydrogen fuel cells used to power the wellsite equipment. Optionally, the method further comprises wherein the solid carbon is used as a fuel source in direct carbon fuel cells or carbon ion batteries for the wellsite equipment. Optionally, the method further comprises wherein the wellsite equipment is used in hydraulic fracturing operations, drilling operations, or cementing operations.

Another embodiment of the present disclosure is a system for powering wellsite equipment comprising: wellbore equipment; captured carbon dioxide; a liquid base fluid; a plurality of carrier droplets; a catalyst; a reaction chamber configured to: receive the captured carbon dioxide, the liquid base fluid, the plurality of carrier droplets, and the catalyst; agitate the captured carbon dioxide, the liquid base fluid, the plurality of carrier droplets, and the catalyst in the reaction chamber; and allow the captured carbon dioxide to react with the catalyst in the reaction chamber to form oxygen gas and solid carbon; and a power source configured to supply the wellsite equipment with power, wherein the power source utilizes the solid carbon, the oxygen gas, or the solid carbon and the oxygen gas. Optionally, the system further comprises wherein the carbon dioxide is captured from exhaust gas produced by wellsite equipment during oil or gas production operations. Optionally, the system further comprises wherein the carbon dioxide is captured from landfills or industry processes. Optionally, the system further comprises wherein the catalyst is a metal, a metal alloy, or a metal salt. Optionally, the system further comprises wherein the metal of the catalyst is selected from the group consisting of copper, nickel, cobalt, iron, manganese, chromium, vanadium, palladium, platinum, gold, silver, ruthenium, rhodium, iridium, aluminum, gallium, indium, thallium, tin, bismuth, and combinations thereof, and wherein the metal salt is selected from the group consisting of a metal chloride, metal fluoride, metal bromide, metal iodide, metal nitrate, metal triflate, silver chloride, silver fluoride, silver bromide, silver iodide, silver triflate, and combinations thereof. Optionally, the system further comprises wherein the catalyst is a plurality of solid particles. Optionally, the system further comprises wherein the plurality of solid particles has a mean particle size in the range of 10 to 100 nanometers. Optionally, the system further comprises wherein the plurality of carrier droplets comprises a pure metal or a metal alloy comprising a post-transition metal selected from the group consisting of aluminum, gallium, indium, thallium, tin, bismuth, and combinations thereof. Optionally, the system further comprises wherein the post-transition metal is alloyed with an alkali metal, alkaline earth metal, actinide metal, lanthanide metal, transition metal, or combinations thereof. Optionally, the system further comprises wherein the plurality of carrier droplets has a mean diameter in the range of 0.1 to 50 micrometers. Optionally, the system further comprises wherein the plurality of carrier droplets comprises a metal that has a melting point below 150° C. Optionally, the system further comprises wherein the liquid base fluid is a polar solvent. Optionally, the system further comprises wherein the plurality of carrier droplets comprises a metal, and wherein the liquid base fluid has a temperature greater than or equal to a melting point of the metal. Optionally, the system further comprises wherein the liquid base fluid, the plurality of carrier droplets, and the catalyst are agitated within the reaction chamber, wherein the agitation is mechanical agitation, and wherein the mechanical agitation is continuously applied to contents in the reaction chamber during a reaction time. Optionally, the system further comprises more than one reaction chamber connected in series. Optionally, the system further comprises wherein the oxygen gas is used to supplement oxygen in hydrogen fuel cells used to power the wellsite equipment. Optionally, the system further comprises wherein the solid carbon is used as a fuel source in direct carbon fuel cells or carbon ion batteries for the wellsite equipment. Optionally, the system further comprises wherein the wellsite equipment is used in hydraulic fracturing operations, drilling operations, or cementing operations.

Therefore, the compositions, methods, and systems of the present disclosure are well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present disclosure.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more inlets, outlets, reaction chambers, etc., as the case may be, and do not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent(s) or other documents that may be incorporated herein by reference, the definitions that are consistent with this specification should be adopted.

1. A method comprising:
using oxygen gas, solid carbon, or oxygen gas and solid carbon obtained from a reaction chamber containing a liquid base fluid, a plurality of carrier droplets, and a catalyst, wherein the reaction chamber is configured to receive captured carbon dioxide to power wellsite equipment.

2. The method according to claim 1, wherein the carbon dioxide is captured from exhaust gas produced by wellsite equipment during oil or gas production operations.

3. The method according to claim 1, wherein the carbon dioxide is captured from landfills or industry processes.

4. The method according to claim 1, wherein the catalyst is a metal, a metal alloy, or a metal salt.

5. The method according to claim 4, wherein the metal of the catalyst is selected from the group consisting of copper, nickel, cobalt, iron, manganese, chromium, vanadium, palladium, platinum, gold, silver, ruthenium, rhodium, iridium, aluminum, gallium, indium, thallium, tin, bismuth, and combinations thereof, and wherein the metal salt is selected from the group consisting of a metal chloride, metal fluoride, metal bromide, metal iodide, metal nitrate, metal triflate, silver chloride, silver fluoride, silver bromide, silver iodide, silver triflate, and combinations thereof.

6. The method according to claim 1, wherein the catalyst is a plurality of solid particles.

7. The method according to claim 6, wherein the plurality of solid particles has a mean particle size in the range of 10 to 100 nanometers.

8. The method according to claim 1, wherein the plurality of carrier droplets comprises a pure metal or a metal alloy comprising a post-transition metal selected from the group consisting of aluminum, gallium, indium, thallium, tin, bismuth, and combinations thereof.

9. The method according to claim 8, wherein the post-transition metal is alloyed with an alkali metal, alkaline earth metal, actinide metal, lanthanide metal, transition metal, or combinations thereof.

10. The method according to claim 1, wherein the plurality of carrier droplets has a mean diameter in the range of 0.1 to 50 micrometers.

11. The method according to claim 1, wherein the plurality of carrier droplets comprises a metal that has a melting point below 150° C.

12. The method according to claim 1, wherein the liquid base fluid is a polar solvent.

13. The method according to claim 1, wherein the plurality of carrier droplets comprises a metal, and wherein the liquid base fluid has a temperature greater than or equal to a melting point of the metal.

14. The method according to claim 1, wherein the liquid base fluid, the plurality of carrier droplets, and the catalyst are agitated within the reaction chamber, wherein the agitation is mechanical agitation, and wherein the mechanical agitation is continuously applied to contents in the reaction chamber during a reaction time.

15. The method according to claim 1, further comprising more than one reaction chamber connected in series.

16. The method according to claim 1, wherein the oxygen gas is used to supplement oxygen in hydrogen fuel cells used to power the wellsite equipment.

17. The method according to claim 1, wherein the solid carbon is used as a fuel source in direct carbon fuel cells or carbon ion batteries for the wellsite equipment.

18. The method according to claim 1, wherein the wellsite equipment is used in hydraulic fracturing operations, drilling operations, or cementing operations.

19. A system for powering wellsite equipment comprising:
wellbore equipment;
captured carbon dioxide;
a liquid base fluid;
a plurality of carrier droplets;
a catalyst;
a reaction chamber configured to:
receive the captured carbon dioxide, the liquid base fluid, the plurality of carrier droplets, and the catalyst;
agitate the captured carbon dioxide, the liquid base fluid, the plurality of carrier droplets, and the catalyst in the reaction chamber; and
allow the captured carbon dioxide to react with the catalyst in the reaction chamber to form oxygen gas and solid carbon; and
a power source configured to supply the wellsite equipment with power, wherein the power source utilizes the solid carbon, the oxygen gas, or the solid carbon and the oxygen gas.

20. The system according to claim 19, wherein the wellsite equipment is used in hydraulic fracturing operations, drilling operations, or cementing operations.
